(19) United States
(12) Patent Application Publication
(10) Pub. No.: US 2007/0044620 A1
(43) Pub. Date: Mar. 1, 2007

(54) Rotary cutting and clamping device for a processing machine

(76) Inventor: Chun-Yin Lin, Yungkang City (TW)

Correspondence Address: J.C. Patents;Suite 250, 4 Venture, Irvine, CA, 92618, US

(21) Appl. No.: 11/218,088

(22) Filed: Aug. 31, 2005

(51) Int. Cl. B26D 1/00

(52) U.S. Cl. 83/651

(57) ABSTRACT

A rotary cutting device for a processing machine has a rotary cutter holder provided with an angle-adjusting device and a height-adjusting device. The angle-adjusting device is able to adjust the position of the rotary cutter of the rotary cutter base at any angle, and the height-adjusting device able to adjust the height of the rotary cutter base for matching with the shape and the position of a work piece A power unit is installed on the rotary cutter base for supplying the rotary cutter with power. A clamping device for a processing machine is provided with a clamping unit base having a clamping unit provided with an upper and a lower clamping member. The clamping unit base is provided with a power unit for adjusting the clamping distance between the two clamping members.

### BACKGROUND OF THE INVENTION

1. Field of the Invention

This invention relates to a rotary cutting device and a clamping device for a processing machine, particularly to ones possible to be adjusted freely in their cutting and clamping position for matching with the shape and the position of a work piece, able to finish processing of the work piece automatically and precisely by only one-time operation, and economical in time and labor as well as cost.

2. Description the Prior Art

Generally, to match with the shape and the position of a work piece being processed, the rotary cutter of a conventional metal processing machine has to be adjusted in position anytime. At present, position adjustment of the rotary cutter of a conventional processing machine is done by manual operation, and the processing height or angle of different work pieces has to be adjusted manually time after time. However, when the rotary cutter is to be adjusted in position manually, the processing machine has to be stopped operating first, thus wasting much labor and time, and after processed, a batch of work pieces, which must be completely the same in shape, may be found different in quality.

Such problems of the conventional device are also disclosed in a Taiwan patent, No. 527225 (PCT/IT/00207), titled, “Multifunction unit for supporting a cutter clamping device”. The unit includes a work table 6 for a cutter clamping device to be fixed thereon, a rotary support post 4, and a fixing post 3 fixed on the a machine tool table 1 and motor units 9, 10 rotating around a preset rotating shaft (B-B) for turning the rotary support post 4 of the work table 6. However, such a device can only process a work piece in a single processing way, but cannot finish the processing by one-time operation for a work piece that needs to be processed in varied ways.

### SUMMARY OF THE INVENTION

The objective of the invention is to offer a rotary cutting device and a clamping device for a processing machine, possible to adjust their cutting and clamping position for matching with the shape and the position of a work piece being processed and able to finish processing automatically and precisely with one round of operation.

The features of the invention are described as follows.

1. The rotary cutting device has a fundamental base provided with a lower base bored with a dove-tail shaped groove to be combined with the dove-tail shaped rail of a processing machine such as a lathe to enable a work piece to be moved left and right together with the fundamental base.

2. The rotary cutting device is provided with a rotary cutter holder having an angle-adjusting device fixed thereon for adjusting the rotary cutter at any angle for matching with the shape of the work piece.

3. The angle-adjusting device of the rotary cutter holder is provided with a braking member. When the rotary cutter holder is adjusted to a proper location by the angle-adjusting device, the rotary cutter will be stopped at the adjusted position by the braking member and fixed at a set angle, able to carry out processing precisely.

4. The rotary cutter holder of the rotary cutting device is provided with a height-adjusting device for adjusting the height of the rotary cutter holder according to the shape of a work piece.

5. The power member of the power unit of the rotary cutting device is preferably a servomotor that is able to detect the condition of the rotary cutter and timely stop the rotary cutter from operating.

6. The clamping device is provided with a clamping unit base fixed on one side of the rotary cutter so that the clamping unit base can be moved together with the rotary cutter.

7. The clamping device is provided with a power unit secured on one side of the clamping unit base, composed of a large power member for carrying out quick adjustment and a small power member for micro adjustment.

8. The clamping device is provided with a clamping unit composed of an upper clamping member and a lower clamping member, which are driven by the power unit to change the distance between the upper and the lower clamping member so as to suit the size of the work piece.

### BRIEF DESCRIPTION OF DRAWINGS

This invention will be better understood by referring to the accompanying drawings, wherein:

FIG. 1 is a perspective view of a rotary cutting device and a clamping device for a processing machine in the present invention;

FIG. 2 is a partial exploded perspective view of the rotary cutting device and the clamping device for a processing machine in the present invention;

FIG. 3 is a partial side cross-sectional view of the rotary cutting device in the present invention;

FIG. 4 is a partial cross-sectional view of the rotary cutting device in the present invention;

FIG. 5 is a cross-sectional view of a first preferred embodiment of the clamping device in the present invention;

FIG. 6 is a cross-sectional view of the first preferred embodiment of the clamping device clamping a work piece for processing in the present invention;

FIG. 7 is a cross-sectional view of a second preferred embodiment of the clamping device; and

FIGS. 8 (A), (B) and (C) are front views of a work piece in the course of being processed in the present invention.

### DETAILED DESCRIPTION OF THE PREFERRED EMBODIMENT

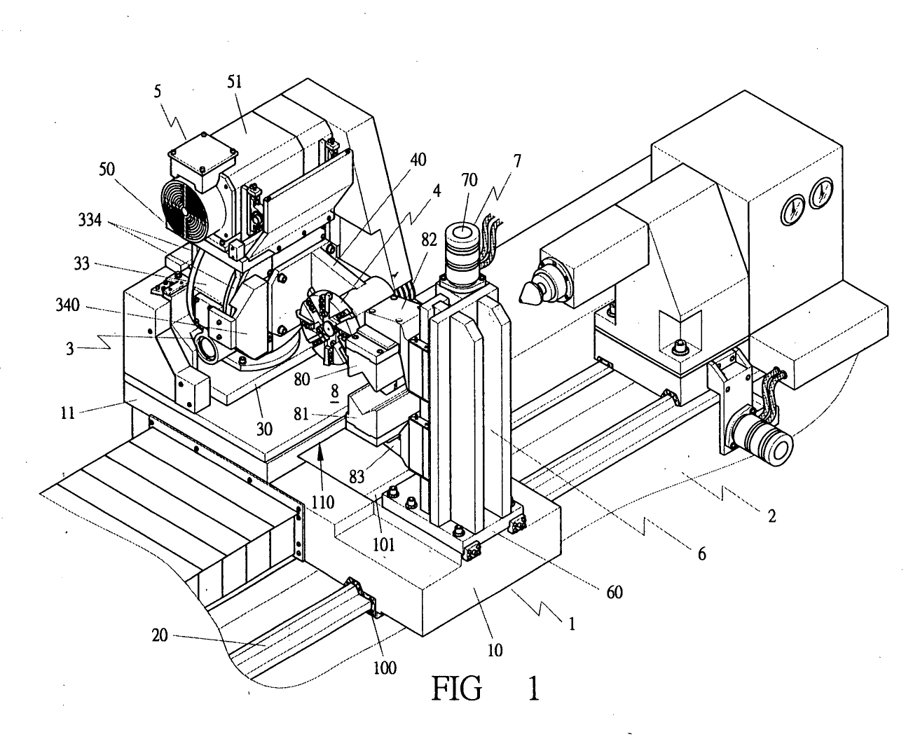

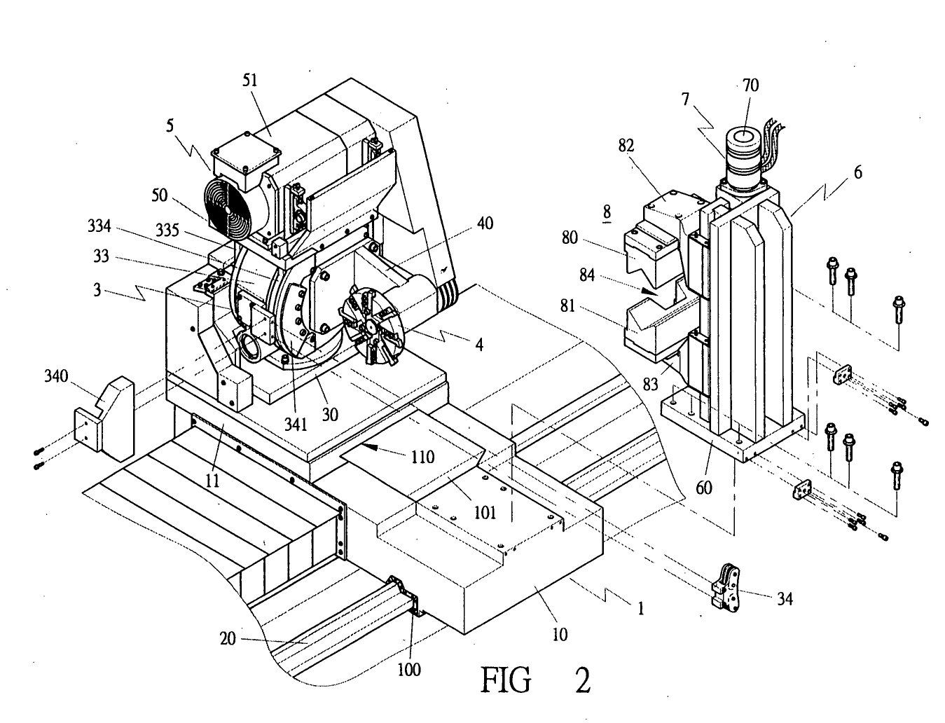

A preferred embodiment of a rotary cutting device for a processing machine in the present invention, as shown in FIGS. 1 to 4, includes a fundamental base 1, a rotary cutter holder 3 and a power unit 5 as main components.

The fundamental base 1 composed of a lower base 10 and an upper base 11. The lower base 10 is bored with a rail groove 100 to be combined with the rail 20 of a processing machine 2 to enable the fundamental base 1 to be moved left and right on the processing machine 2. The lower base 10 is further formed with a dovetail shaped rail 101. The upper base 11 is bored with a dovetail shaped groove 110 to be combined with the dovetail shaped rail 101 of the lower base 10 to enable the upper base 11 to be moved back and forth. Thus, the fundamental base 1 can be moved along definite tracks to match with the position of a work piece being processed.

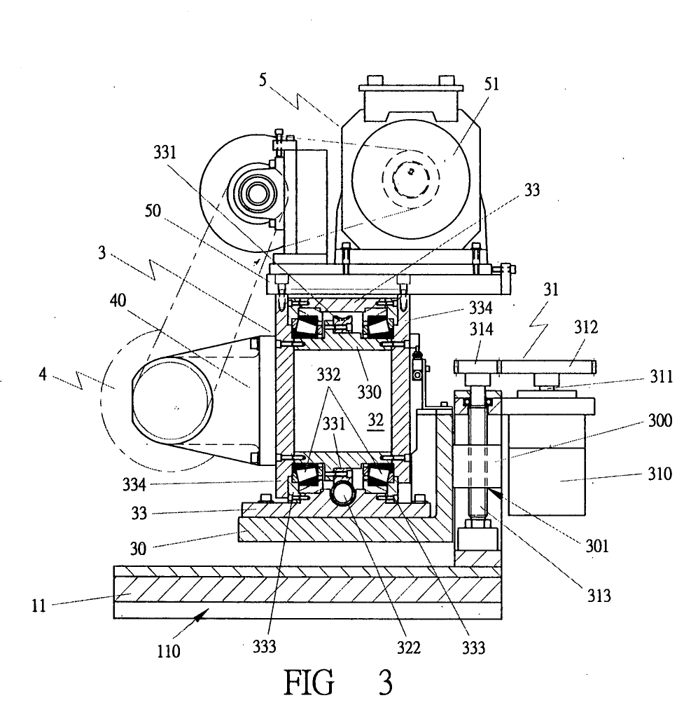

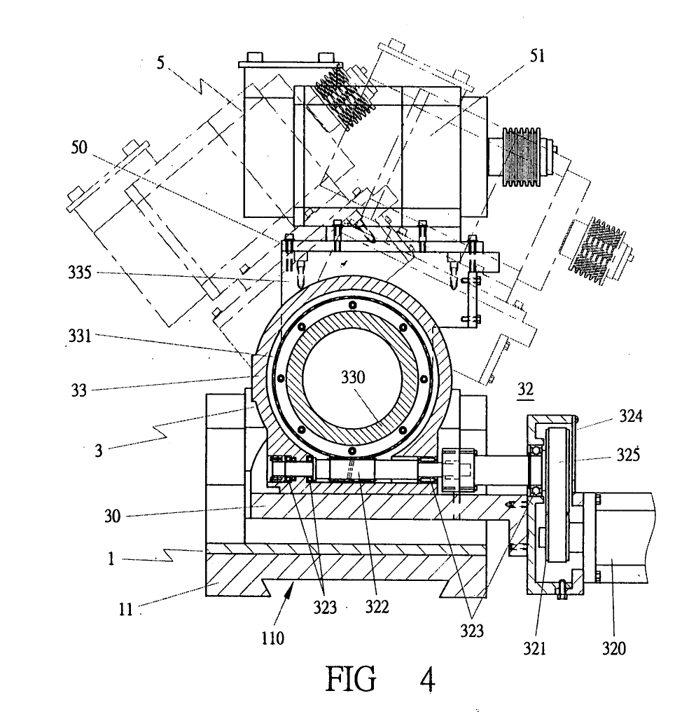

The rotary cutter holder 3, as shown in FIGS. 3 and 4, is provided with a fixing base 30 and a height-adjusting device 31. The fixing base 30 has one side fixed with a combining base 300 with an inner threaded hole 301 to be combined with the height-adjusting device 31. The height-adjusting device 31 is provided with a power member 310, which may be a conventional electric motor or an oil pressure motor. The power member 310 has its center shaft 311 provided with a gear 312 engaging with the gear 314 of a threaded rod 313 that is threadably combined with the inner threaded hole 301 of the combining base 300. Thus, the rotary cutter holder 3 can be adjusted in height by the height-adjusting device 31 in accordance with the shape and the position of the work piece. Further, an angle-adjusting device 32 is assembled on the fixing base 30 and installed with a power member 320 having its center shaft fitted with a pulley 321. The angle-adjusting device 32 is provided with a worm 322 having its opposite sides supported by plural bearings 323. The worm 322 is positioned above the fixing base 30 and fitted with a pulley 324, which is connected with the pulley 321 of the power member 320 by means of a toothed transmission belt 325 that actuates the two pulleys 321, 324 to rotate clockwise, as shown in FIGS. 3 and 4.

Further, the rotary cutter device 3 is provided with an upper fixing base 33 fitted in the interior with a rotating shaft 330 fixed thereon with a worm gear 331 engaged with the worm 322, letting the rotating shaft 330 of the upper fixing base 33 actuated to rotate by the power member 320. The rotating shaft 330 has its opposite sides respectively provided with a roller bearing 332 pressed firmly by a tightening cover 333 to keep the rotating shaft rotating, and the two tightening covers 333 are respectively secured at the opposite sides of the upper fixing base 33. Furthermore, the rotating shaft 330 has its opposite sides respectively fixed thereon with a front and a rear cover plate 334. The table 40 of the rotary cutter 4 is secured on the front cover plate 334, and the table 50 of the power unit 5 is fixed on the front and the rear cover plate 334. Thus, the processing angles of the rotary cutter 4 can be adjusted freely by the angle-adjusting device 32 for matching with the shape of the work piece being processed.

Moreover, the angle-adjusting device 32 of the rotary cutter holder 3 is provided with a brake 34 secured at one side of the upper fixing base 33 and covered by a cover plate 340, and the front cover plate 334 of the rotating shaft 330 is fitted with a brake horse-shoe 341, with the brake 34 interacting with the brake horse-shoe 341 to carry out braking. Thus, when the rotary cutter holder 3 is adjusted to a proper location by the angle-adjusting device 32, the rotary cutter 4 can be stopped at the proper location by the brake 34 and fixed at a set angle for processing the work piece precisely.

The power unit 5 is provided with a power member 51, which is preferably a servo motor; therefore, the rotary cutters 4 processing the work piece may respond to the power member 51 so that the condition of each of the rotary cutters 4 can be detected. When one of the cutters is worn off in the course of processing and the processing strength of the rotary cutters 4 upon the work piece is found different, it is necessary to stop the rotary cutter 4 in due time so as to carry out the processing with precision.

A first preferred embodiment of a clamping device for a processing machine in the present invention, as shown in FIGS. 1, 2, 5 and 6, includes a clamping unit base 6, a power unit 7 and a clamping members 8 as main components.

The clamping unit base 6 positioned at one side of the rotary cutting device is provided with a bottom base 60 secured on the lower base 10 of the fundament base 1 of the rotary cutting device to enable the clamping unit base 6 to be moved synchronously together with the rotary cutting device. Further, the clamping unit base 6 is provided at one side with an upper fixing base 61 and a lower fixing base 62, which are positioned in a symmetrical way. The upper and the lower fixing base 61 and 62 are respectively bored with a through hole 610 and 620.

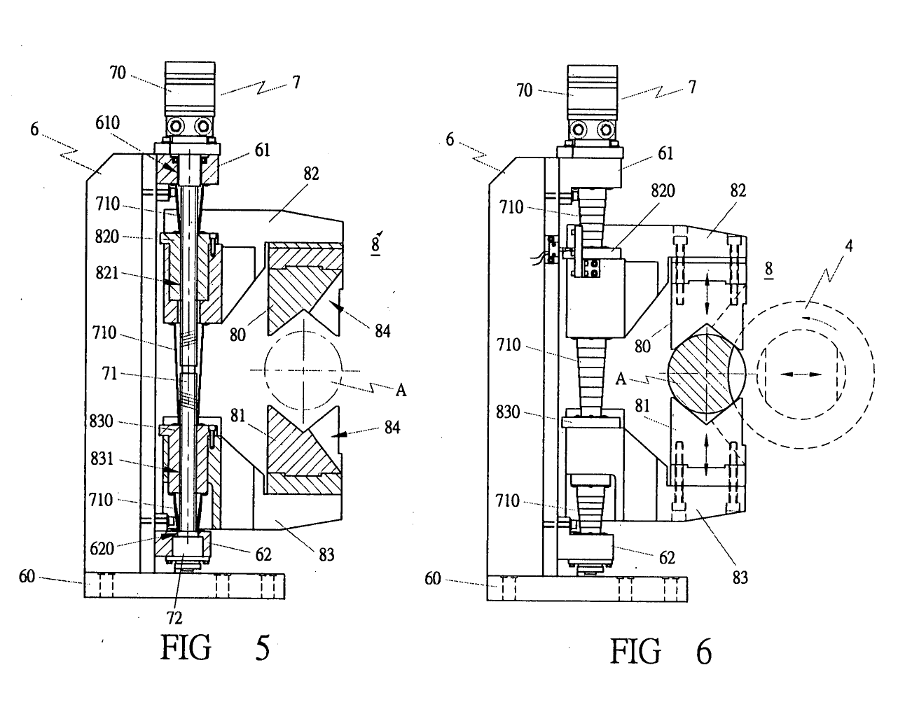

The power unit 7 positioned on the upper and the lower fixing base 61 and 62 consists of a large power member 70 and a small power member 72. The large power member 70 may be an oil pressure motor or an electric motor, secured on the upper fixing base 61 and having its rotating shaft fitted with a threaded rod 71, as shown in FIG. 5, with a protecting member 711 covered around the threaded rod 71, as shown in FIG. 6. The small power member 72 may be an oil pressure cylinder or an air pressure cylinder, having its shaft fixed with one end of the threaded rod 71, as shown in FIG. 5.

Thus, the large power member 70 functions to shift the clamping member 8 for a long distance, and the small power member 72 functions to shift the clamping members 8 for a micro distance, able to produce a proper clamping force according to the processing condition of the work piece and enabling the clamping members 8 to be released timely in accordance with the shifting of the rotary cutters 4.

The clamping members 8 are provided with an upper clamping member 80 and a lower clamping member 81, which are actuated by the power unit 7 to change the champing distance for matching with the size of the work piece (A). The upper and the lower clamping member 80, 81 are respectively fixed on one end of two cantilevers 82 and 83, and respectively formed with a cutter entering mouth 84 for enabling the surface of the work piece (A) to be processed on the outside by the rotary cutter 4, as shown in FIG. 6. Simultaneously, the upper and the lower clamping member 80, 81 can timely release the work piece (A) in accordance with the processed position of the work piece (A) for facilitating synchronous shifting of the rotary cutters 4, the clamping unit base 6 and the components on the clamping unit base 6. The two cantilevers 82, 83 respectively have one end extending sideward and fixed with a toothed base 820, 830 respectively having an inner threaded hole 821, 831 to be threadably combined with the threaded rod 71, as shown in FIG. 5.

By so designing, when the power unit 7 operates, the two toothed bases 820, 830 will be respectively actuated to move up and down reversely to each other so as to change the distance between the upper and the lower clamping member 80 and 81 for suiting to the size of the work piece.

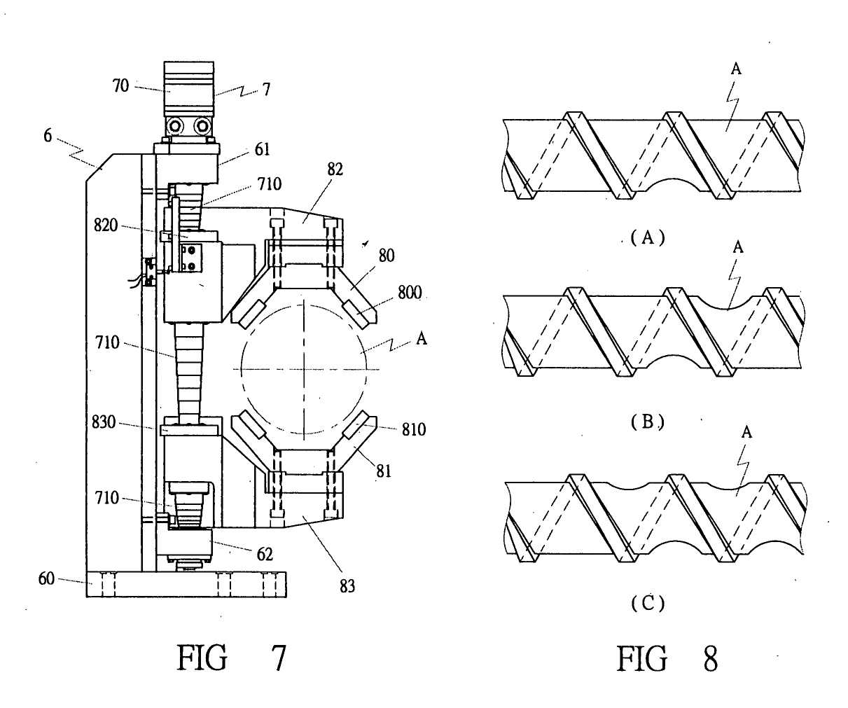

The upper and the lower clamping member 80 and 81 of the clamping unit 8 can be made into a same shape as that of a work piece, or made into different shapes according to practical needs. For instance, cushion blocks 800 and 810 can be fixed on the surface of the upper and the lower clamping members 80 and 81 for matching with the shape and the size of the work piece, as shown in FIG. 7.

Thus, when a work piece is comparatively long, the clamping unit 8 can be automatically adjusted in its clamping position in accordance with the processing position of the rotary cutters 4; therefore, each work can be processed completely by only one-time operation after it is fixed on the processing machine for processing. Substantially, the rotary cutting device and the clamping device for a processing machine in the present invention are able to carry out processing of work pieces with less time, less cost and more precision.

While the preferred embodiments of the invention have been described above, it will be recognized and understood that various modifications may be made therein and the appended claims are intended to cover all such modifications that may fall within the spirit and the scope of the invention.

What is claimed is:

1. A rotary cutting device and a clamping device for a processing machine, said rotary cutting device comprising:
a fundamental base provided with a lower base and an upper base, said lower base provided with a dove-tail shaped rail, said upper base bored with a dove-tail shaped groove, said dove-tail shaped groove combined with said dove-tail shaped rail of said lower base:
a rotary cutter holder provided with a fixing base, said fixing base having one side secured with a combining base, said combining base bored with an inner threaded hole:
a height-adjusting device installed with a power unit, said power unit provided with a gear, said gear engaged with a gear of a threaded rod, said threaded rod threadably combined with said inner threaded hole of said combining base:
an angle-adjusting device positioned on said fixing base of rotary cutter holder, said angle-adjusting device provided with a power unit, said power unit provided with a pulley, said angle-adjusting device further provided with a worm supported by plural bearings, said worm positioned on said fixing base of rotary cutter holder, said worm fitted with a pulley, said pulley of said power unit and said pulley of said worm connected by a toothed transmission belt:
an upper fixing base provided with a rotating shaft, said rotating shaft provided with a worm gear, said worm gear engaged with said worm of said angle-adjusting device, said rotating shaft having its opposite sides respectively provided with a roller bearing, said roller bearings respectively pressed firmly by a tightening cover, said tightening cover secured on the opposite sides of said upper fixing base, said rotating shaft having its front and rear side respectively fixed with a cover plate, the rotary cutter firmly assembled on said front cover plate, the table of a power unit fixed on said front and said rear cover plate:
said clamping device comprising;
a clamping unit base having a bottom base and positioned on one side of a cutter held by said rotary cutter base, said clamping unit base moving synchronously with said cutter, said bottom base secured on a rail of a lathe, said clamping unit having an upper fixing base and a lower fixing base symmetrically fitting with said upper fixing base, said upper and said lower fixing base both having a through hole;
a power unit positioned on said upper and said lower fixing base of said clamping unit base, said power unit composed of a large power member and a small power member, said large power member fixed on said upper fixing base and having a rotating shaft fitted with a threaded rod, said small power member having a shaft firmly connected with one end of said threaded rod: and,
a clamping members consisting of an upper and a lower clamping member, said upper and said lower clamping members driven by said power unit to change the clamping distance for suiting to the size of a work piece.

2. The rotary cutting device and the clamping device for a processing machine as claimed in claim 1, wherein said fundamental base is provided with said lower base bored with a rail groove to be combined with the rail of a processing machine.

3. The rotary cutting device and the clamping device for a processing machine as claimed in claim 1, wherein said angle-adjusting device of said rotary cutter holder is provided with a braking member having a brake fixed at one side of said upper fixing base and covered by a cover plate, and said front cover plate of said upper fixing base is provided with a brake horse-shoe, said brake horse-shoe interacting with said brake to carry out braking.

4. The rotary cutting device and the clamping device for a processing machine as claimed in claim 1, wherein said threaded rod of said power unit of said clamping device is covered around with a protecting member.

5. The rotary cutting device and the clamping device for a processing machine as claimed in claim 1, wherein said upper and said lower clamping member of said clamping device are respectively formed with a cutter entering mouth.

6. The rotary cutting device and the clamping device for a processing machine as claimed in claim 1, wherein said upper and said lower clamping member of said clamping device have their surfaces respectively fixed thereon with cushion blocks.
